(19) United States
(12) Patent Application Publication
(10) Pub. No.: US 2021/0283911 A1
(43) Pub. Date: Sep. 16, 2021

(54) FLUID EJECTION DEVICE WITH MULTI-CHAMBER NOZZLE

(71) Applicant: HEWLETT-PACKARD DEVELOPMENT COMPANY, L.P., Spring, TX (US)

(72) Inventors: Ning Ge, Palo Alto, CA (US); David George, Palo Alto, CA (US); Lihua Zhao, Corvallis, OR (US); Qingqiao Wei, Corvallis, OR (US); James Abbott, Corvallis, OR (US); Esteve Comas, Sant Cugat del Valles (ES)

(73) Assignee: HEWLETT-PACKARD DEVELOPMENT COMPANY, L.P., Spring, TX (US)

(21) Appl. No.: 16/343,834

(22) PCT Filed: Feb. 7, 2017
(86) PCT No.: PCT/US2017/016823

§ 371 Date: Apr. 22, 2019

(51) Int. Cl. B41J 2/14; B29C 64/205; B29C 64/295

(52) U.S. Cl. CPC B41J 2/14032; B29C 64/205; B33Y 30/00; B41J 2/14072; B29C 64/295

(57) ABSTRACT

In one example In accordance with the present disclosure, a fluid ejection device is described. The fluid ejection device Includes a number of nozzles to eject fluid. Each nozzle Includes multiple firing chambers to hold fluid. The multiple firing chambers are separated: by a chamber partition. Each nozzle also includes a shared nozzle orifice in a substrate through which to dispense fluid. Each nozzle also Includes multiple ejectors, at least one ejector disposed in each firing chamber, in a common channel of the nozzle, fluid from the multiple firing chambers Is mixed, A height of the common channel is defined by the substrate and the chamber partition and is less than a width of the shared nozzle orifice.

### BACKGROUND

Fluid ejection devices such as inkjet printheads are widely used for precisely, and rapidly, dispensing small quantities of fluid. Such fluid ejection devices come in many forms. For example, fluid ejection devices may dispense functional agents in an additive manufacturing process or may dispense ink on a print medium such as paper, or other two-dimensional or three-dimensional surface.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a representation of a fluid ejection device with a multi-chamber nozzle, according to an example of the principles described herein.

FIG. 2 is a simplified top diagram of an additive manufacturing apparatus with a multi-chamber nozzle, according to an example of the principles described herein.

FIGS. 3A and 3B are diagrams of a multi-chamber nozzle powered by a single field effect transistor (FET), according to an example of the principles described herein.

FIGS. 4A and 4B are diagrams of a multi-chamber nozzle powered by multiple FETs, according to an example of the principles described herein.

FIG. 5 is a diagram of a multi-chamber nozzle having asymmetrical firing chambers, according to an example of the principles described herein.

FIG. 6 is a flowchart of a method for mixing fluids in a multi-chamber nozzle of a fluid ejection device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Fluid ejection devices such as inkjet printheads and additive manufacturing apparatuses are widely used for precisely, and rapidly, dispensing small quantities of fluid. Such fluid ejection devices come in many forms. For example, fluid election devices may dispense functional agents in an additive manufacturing process or may dispense ink on a print medium such as paper. One example of such a functional agent is a fusing agent in an additive manufacturing device, which fusing agents facilitates the hardening of build material to form a three-dimensional product. In other words, the systems an methods described herein may be implemented in a two-dimensional printing, i.e., depositing fluid on a substrate, and in three-dimensional printing, i.e., depositing a fusing agent or other functional agent on a powder base to form a three-dimensional printed product. In these examples, an ejector in the firing chamber forces the fluid out the nozzle orifice. Examples of ejectors include thermal ejectors or piezoelectric ejectors.

The nozzles may be arranged in columns or arrays such that properly sequenced ejection of from the nozzles causes characters, symbols, and/or other patterns to be formed on the surface. The surface may be a layer of build material or other three-dimensional surface in an additive manufacturing apparatus. In other examples, the surface is a medium such as paper in an inkjet printer for two-dimensional printing. In operation, fluid flows a reservoir to the fluid ejection device. In some examples, the fluid ejection device may be broken up into a number on dies with each die having a number of nozzles. To create the characters, symbols, and/or other pattern, a printer, additive manufacturing apparatus, multi-jet fusion device, or other component in which the fluid ejection device is installed sends electrical signals to the fluid ejector device via electrical bond pads on the fluid ejection device. The fluid ejection device then ejects a small droplet of fluid from the reservoir onto the surface. These droplets combine to form an image or other pattern on the surface.

The fluid ejection device includes a number of components for depositing a fluid onto a surface. For example, the fluid ejection device includes a number of nozzles. A nozzle includes an ejector, a firing chamber, and a shared nozzle orifice. The shared nozzle orifice allows fluid, such as ink or a functional agent, such as a fusing agent, to be deposited onto a surface, such as a powder build material or a print medium. The firing chamber includes a small amount of fluid. The ejector is a mechanism for ejecting fluid through the shared nozzle orifice from a firing chamber. The ejector may include a thermal resistor or other thermal device, a piezoelectric element, or other mechanism for ejecting fluid from the firing chamber.

For example, the ejector may be a thermal resistor. As the thermal resistor heats up in response to an applied energy, such as a supplied voltage pulse. As the thermal resistor heats up, a portion of the fluid in the firing chamber vaporizes to form a bubble. This bubble pushes fluid out the shared nozzle orifice and onto the surface. As the vaporized fluid bubble pops, a negative pressure within the firing chamber draws fluid into the firing chamber from the fluid supply, and the process repeats. This system is referred to as a thermal inkjet system. In these examples, the amount of heat to initialize ejection may vary depending on the volatility of the fluid to be ejected, the configuration of the firing chamber, and other such factors. For example, the system may be a volatility-enhanced thermal inkjet system where the expulsion momentum of the fluid is enhanced by the volatility of the nucleated fluid.

In another example, the ejector may be a piezoelectric device. As a voltage is applied, the piezoelectric device changes shape which generates a pressure pulse in the firing chamber that pushes a fluid out the shared nozzle orifice and onto the surface.

While such fluid ejection devices undoubtedly have advanced the field of precise fluid delivery, some conditions impact their effectiveness. For example, in some scenarios, foreign particles may enter the firing chamber. Some of these foreign particles may be of sufficient size, be present in sufficient quantities, or have other attributes that negatively affect the operation of the fluid ejection device. Such complications may arise in both three-dimensional printing operations two-dimensional printing operations.

As a specific example, during a type of additive manufacturing referred to as multi-jet fusion, many functional agents are used. Some functional agents deliver materials to a volume of build material that enhance the properties for a final part. One example is a hardener. Another specific example of a functional agent in an additive manufacturing process is a fusing agent. A powder build material is deposited in a build area. A fusing agent is then disposed onto portions of the powder build material that are to be fused to form a layer of a three-dimensional object. The fusing agent increases the energy absorption of the underlying build material. Accordingly, as energy is applied to a surface of the build material, the build material that has received the fusing agent, and therefore has increased energy absorption characteristics, fuses while that portion of the build material that has not received the fusing agent remains in powder form. This process is repeated in a layer-wise fashion to generate a three-dimensional object.

In this example, particulate matter from a powder-based building volume could enter the firing chamber of the nozzle that dispenses the fusing agent. For example, the ejection of the fusing agent may be done with sufficient velocity to dislodge particulate matter from the build area. The dislodged particulate matter could enter and clog the nozzle orifice leading to irregular fluid deposition, or may inhibit fluid deposition altogether.

The clogging of the nozzle orifice may even damage the ejector. For example, the fluid in a fluid ejection device serves to cool the ejector following heating and vaporization of a fluid bubble. If the nozzle orifice is clogged, this may impact the draw of fluid from the reservoir into the firing chamber, thus exposing the ejector to air for a longer period of time. This increased air exposure can lead to premature failure of the ejector and can further degrade fluid ejection performance. That is, the clogged nozzle will be over-heated if no fluid is refilled into the firing chamber to cool the ejector. This decreases the. reliability of the nozzle, and may result in failure of the nozzle.

Accordingly, the present specification describes devices and methods tor preventing the intrusion of particulate matter. Specifically, the present specification describes a nozzle that has multiple firing chambers. A chamber partition separates the firing chambers and defines a common channel, which common channel is in fluid communication with the shared nozzle orifice through which fluid is dispensed. Each firing chamber has an ejector that, as described above, forces a fluid drop out of the corresponding firing chamber. Fluid drops from each firing chamber enter the common channel and are mixed. The common channel inlet sizes are narrower than a width of the nozzle. The common channel inlets are narrower such that particulate matter is prevented from traveling through the inlets, and into the firing chambers. Accordingly, particulate entry into the firing chambers is prevented.

Specifically, the present application describes a fluid ejection device. The fluid ejection device includes a number of nozzles to elect fluid. Each nozzle includes multiple firing chambers to hold fluid. The multiple firing chambers are separated by a chamber partition. Each nozzle also includes a shared nozzle orifice in a substrate through which to dispense fluid. Each nozzle also includes multiple ejectors. At least one ejector is disposed in each firing chamber. In a common channel of the nozzle, fluid from the multiple firing chambers is mixed. A height of the common channel 1) is defined by the substrate and the chamber partition and 2) is less than a width of the shared nozzle orifice.

The present specification also describes an additive manufacturing apparatus. The additive manufacturing apparatus includes a build material distributor to successively deposit layers of build material into a build area. At least one agent distributor of the additive manufacturing apparatus includes at least one fluid ejection device to distribute agent onto the layers of build material and a nozzle having multiple firing chambers, the nozzle to eject agent from the at least one fluid ejection device.

The present specification also describes a method for electing fluid from a fluid ejection device. According to the method, a first ejector in a first firing chamber is activated to deliver fluid to a common channel of the fluid ejection device. A second ejector in a second firing chamber is also activated to deliver fluid to the common channel. In a common channel of the fluid ejection device, a first fluid drop from the first firing chamber and a second fluid drop from the second firing chamber are mixed and the merged fluid drop is passed through a shared nozzle orifice, which has a width greater than a height of the common channel.

In one example, using such a fluid ejection device with a multi-chamber nozzle 1) prevents clogging of the fluid ejection device, 2) maintains desirable fluid drop properties, 3) ejects foreign particulate matter away from the nozzle, 4) distributes firing energy among the multiple ejectors thus reducing electrical and thermal stress of the ejectors, and 5) provides for mixing different types, and different quantities, of fluid. However, it is contemplated that the devices disclosed herein may address other matters and deficiencies in a number of technical areas.

As used in the present specification and in the appended claims, the term ‘nozzle’ refers to an individual component of a fluid ejection device that dispenses fluid onto a surface. The nozzle includes at least a firing chamber, an ejector, and a shared nozzle orifice.

Still further, as used in the present specification and in the appended claims, the terms “height” and “width” are used according to a particular orientation of the fluid ejection device, but the terms could be used in other orientations. More generally, a “height” of a common channel refers to a direction parallel of fluid flow Out of the shared nozzle orifice and a “width” of the common channel refers to a direction perpendicular to fluid flow out of the nozzle.

Even further, as used in the present specification and in the appended claims, the term “a number of” or similar language is meant to be understood broadly as any positive number including 1 to infinity.

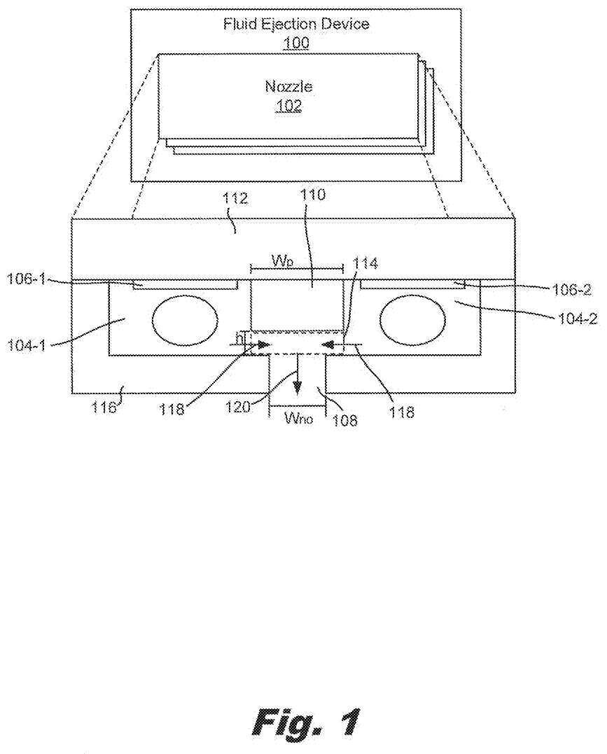

FIG. 1 is a representation of a fluid ejection device (100) with a maid-chamber nozzle (102), according to an example of the principles described herein. The fluid ejection device (100) refers to a deice that is used to eject fluid, such as a factorial agent or ink, onto a surface such as a print medium such as paper or a build material bed in an additive manufacturing apparatus. To eject the fluid, the fluid ejection device (100) includes a number of nozzles (102) to eject an amount of fluid. Each nozzle (102) includes multiple firing chambers (104-1, 104-2) to hold the amount of fluid that is to be expelled by the ejectors (106-1, 106-2). As used in the present specification the indicator represents different instances of a component. Fluid passes into the firing chambers (104) via a fluid feed channel that fluidically connects the nozzle (102) to a fluid supply such as an ink reservoir or a fluid agent reservoir.

The firing chambers (104-1, 104-2) are separated from one another by a chamber partition (110). The chamber partition (110) may be made from the same material as a substrate (112) on which the ejectors (106-1, 106-2) are disposed. The material that forms the substrate (112) and chamber partition (110) may be any material including SU8. The chamber partition (110) separates the firing chambers (104-1, 104-2) and in part defines a common channel (114) that MERGES fluid originating from all the firing chambers (104-1, 104-2).

It is through a shared nozzle orifice (108) that the fluid is dispensed. Ejectors (106) disposed within the firing chambers (104) work to eject the amount of fluid through the shared nozzle orifice (108). As can be seen in FIG. 1, the ejector (110) may be disposed in a substrate (112).

Returning to the ejectors (106), the ejectors (106) may be of varying types. For example, the ejectors (106) may be thermal resistors, such as a thermal inkjet resistor (TIJ resistor). Thermal resistors heat up in response to an applied voltage. As the thermal resistors heat up, a portion of the fluid in the firing chambers (104) vaporizes to form a bubble. This bubble pushes fluid through an inlet into the common channel (114) ad indicated by the arrows 118. As the vaporized fluid bubble pops, a negative pressure within the firing chambers (104) draws fluid into the firing chambers (104) from the fluid supply via the fluid feed channels, and the process repeats. This system is referred to as a thermal inkjet system. In some examples, the system may be a volatility enhanced thermal inkjet system where the expulsion momentum of the fluid is enhanced by the volatility of the nucleated fluid.

In another example, the ejectors (106) may be piezoelectric devices. As a voltage is applied, the piezoelectric devices change shape, which generates a pressure pulse in the firing chambers (104) that push a fluid into the common channel (114).

The common channel (114) refers to a portion of the nozzle (102) that is defined by 1) a substrate (116) in which the shared nozzle orifice (108) is formed and 2) the chamber partition (110). A height of the common channel (114), indicated in FIG. 1 as h, refers to that distance between the chamber partition (110) and the shared nozzle orifice substrate (116). In this common channel (114), fluid received from both a first firing chamber (104-1) and a second firing chamber (104-2) is mixed to form a single merged fluid drop. The merged fluid drop is then expelled through the shared nozzle orifice (108) due to the force generated by the vaporization of fluid bubbles in both firing chambers (104) or the pressure pulse generated in the firing chambers (104).

As can be seen in FIG. 1, the height h, of the common channel (114) is less than a width, wₙₒ, of the shared nozzle orifice (108). Doing so prevents the entry of particulate matter back into either of the firing chambers (104). Specifically, the width of the shared nozzle orifice (108), wₙₒ, may be sufficient to allow drops of fluid to pass through, while preventing the passage of particulate matter. For example, the shared nozzle orifice (108) may be greater than 50 micrometers wide but the height, h, of the common channel may be less than 50 micrometers, for example 26 micrometers. In this example, the particulate matter, which has a mean size of 50 micrometers, may pass through the shared nozzle orifice (108) but is prevented entry into the firing chambers (106) as it is too large to pass through the inlets, which have a height of less than 50 micrometers.

To further prevent entry of particulate matter into either of the firing chambers (104), the width of the chamber partition (110), wₚ, may be greater than a width of the shared nozzle orifice (108), wₙₒ. In this example, fluid delivered to the common channel (114) from the first firing chamber (104-1) and fluid delivered to the common channel (114) from the second firing chamber (104-2) travel along a first plane as indicated by the arrows 118 and the merged fluid drop passes through the shared nozzle orifice (106) along a second plane as indicated by the arrow 120. In this fashion, the path of the fluid passes through inlets that are less wide than the particulate matter, thus preventing entry of particulate matter into the firing chambers (104).

Including a multi-chamber (104) nozzle (102 in the fluid ejection device (100) may extend the life of the fluid ejection device (100) and enhance its performance. For example, as described above, due to any number of mechanisms, particulate matter may enter the fluid ejection device (100) and may impede the precise and accurate ejection of fluid. In some cases, the shared nozzle orifice (108) is blocked completely. Accordingly, a multi-chamber (104) nozzle (102) with a common channel (114) having a height narrower than a width of the shared nozzle orifice (108) prevents the particulate matter from entering the firing chambers (104).

Moreover, such particulate matter could affect the operating life of the fluid ejection device (100). Specifically, the ingress of certain types and/or amounts of particulate matter may impact the flow of fluid into and out of the firing chambers (104). If a reduced flow is generated, then the fluid may not cover the ejectors (106) for a period of time. As the fluid covering the ejectors (106) dissipates heat generated by the ejector to create the vapor bubble, if fluid is prevented from contacting, and thereby cooling, the ejectors (106) the ejectors (106) may overheat, and degrade in operation more quickly.

Using a multi-chamber (104) nozzle (102) not only prevents entry of particulate matter into either firing chamber (104), but also actively ejects particulate matter from the nozzle (102). For example, during the ejection of a fluid drop, any particulate matter that may be in the common channel (114) is pushed out of the shared nozzle orifice (108) by the fluid drop to be ejected.

A multi-chamber (104) nozzle (102) also extends the life of the nozzle (102) as a whole. More specifically, the energy used to generate a desired merged drop volume can be distributed among the multiple ejectors (106). For example, if a desired merged drop volume is 9 picoliters, each ejector (106) may be sized or operated to generate a drop volume of 4.5 picoliters. The individual 4.5-picoliter drops are then merged in the common channel (114) to form the 9 picoliter merged drop. In this example, as a smaller drop is generated in each firing chamber (104), less energy can be used to generate the drops and therefore smaller ejectors (106) may be used, which is more efficient. Moreover, the generation of a smaller bubble results in less electrical and thermal stress on the ejectors (106) giving them a longer life.

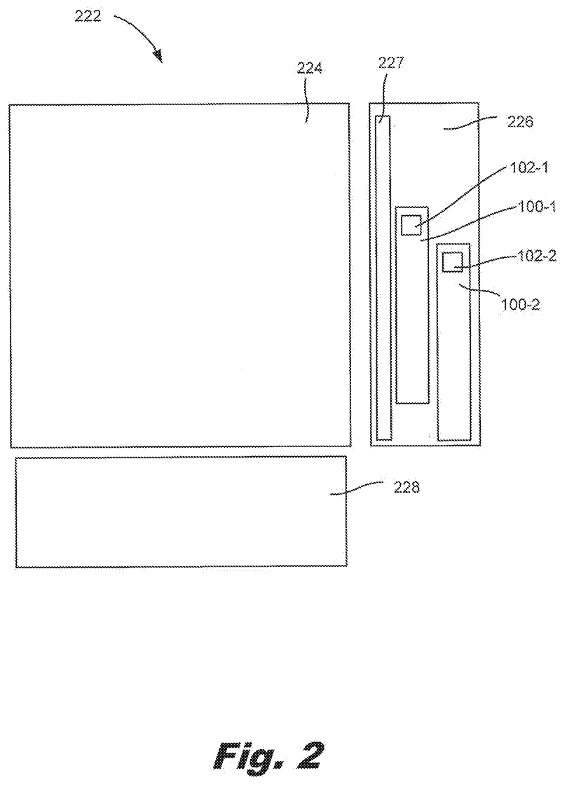

FIG. 2 is a simplified top diagram of an additive manufacturing apparatus (222) with a multi-chamber nozzle (FIG. 1, 102), according to an example of the principles described herein. In general, apparatuses for generating three-dimensional objects may be referred to as additive manufacturing apparatuses 222). The apparatus (222) described herein may correspond to three-dimensional printing systems, which may also be referred to as three-dimensional printers. In an example of an additive manufacturing process, a layer of build material may be formed in a build area (224). In the additive manufacturing process any number of functional agents may be deposited on the layer of build material. One such example is a fusing agent that facilitates the hardening of the powder build material. In this specific example, the fusing agent may be selectively distributed on the layer of build material in a pattern of a layer of a three-dimensional object. An energy source may temporarily apply energy to the layer of build material. The energy can be absorbed selectively into patterned areas formed by the fusing agent and blank areas that have no fusing agent, which leads to the components to selectively fuse together. This process is then repeated until a complete physical object has been formed. Accordingly, as used herein, a build layer may refer to a layer of build material formed in a build area (224) upon which the functional agent may be distributed and/or energy may be applied.

Additional layers may be formed and the operations described above may be performed for each layer to thereby generate a three-dimensional object. Sequentially layering and fusing portions of layers of build material on top of previous layers may facilitate generation of the three-dimensional object. The layer-by-layer formation of a three-dimensional object may be referred to as a layer-wise additive manufacturing process.

In examples described herein, a build material may include a powder-based build material, where the powder-based build material may include wet and/or dry powder-based materials, particulate materials, and/or granular materials. In some examples, the build material may be a weak light absorbing polymer, In some examples, the build material may be a thermoplastic. Furthermore, as described herein, the functional agent may include fluids that may facilitate fusing of build material when energy is applied. The fusing agent may be a light absorbing liquid, an infrared or near infrared absorbing liquid, such as a pigment colorant.

The additive manufacturing apparatus (222) includes a build material distributor (228) to successively deposit layers of the build material in the build area (224). The build material distributor (228) may include a wiper blade, a roller, and/or a spray mechanism. The build material distributor (228) may be coupled to a scanning carriage. In operation, the build material distributor (228) forms build material in the build area (224) as the scanning carriage moves over the build area (224) along the scanning axis to form a build layer of build material in the build area (224). While FIG. 2 depicts the build material distributor (228) as being orthogonal to the agent distributor (226), in some examples the build material distributor (228) may be in line with the agent distributor (226).

The additive manufacturing apparatus (222) des at least one agent distributor (226). An agent distributor (226) includes at least one fluid ejection device (100-1, 100-2) to distribute a functional agent onto the layers of wild material.

Returning to the additive manufacturing apparatus (222), as described above, in one specific example of a functional agent, the fusing agent increases the energy absorption of portions of the build material that receive the fusing agent. A fluid ejection device (100) may include at least one printhead (e.g., a thermal ejection based printhead, a piezoelectric ejection based printhead, etc.). In some examples, the agent distributor (226) is coupled to a scanning carriage, and the scanning carriage moves along a scanning axis over the build area (224). In one example, printheads that are used in inkjet printing devices may be used as an agent distributor (226). In this example, the fusing agent may be ink. In other examples, an agent distributor (226) may include other types of fluid ejection devices (100) that selectively eject small volumes of fluid.

The agent distributor (226) includes at least one fluid ejection device (100) that has a plurality of fluid ejection dies arranged generally end-to-end along a width of the agent distributor (226). The at least one fluid ejection device (100) may include a plurality of printheads arranged generally end-to-end along a width of the agent distributor (226). In such examples, the width of the agent distributor (226) corresponds to a dimension of the build area (224). For example, a width of the agent distributer (226) may correspond to a width of the build area (224). The agent distributor (226) selectively distributes an agent on a build layer in the build area (224) concurrent with movement of the scanning carriage over the build area (224). In some example apparatuses, the agent distributor (226) includes nozzles (102), including shared nozzle orifices (FIG. 1, 108), through which the fusing agent is selectively ejected. In such examples, the agent distributor (226) includes a nozzle surface in which a plurality of shared nozzle orifices are formed.

The additive manufacturing apparatus (222) also includes nozzles (102) that include multiple firing chambers (FIG. 1, 104). Specifically, a first nozzle (102-1) is disposed in a first fluid ejection device (100-1) and a second nozzle (102-2) is disposed in a second fluid ejection device (100-2).

The additive manufacturing apparatus (222) also includes at least one heater (227) to selectively fuse portions of the build material to form an object via the application of heat to the build material. A heater (227) may be any component that applies thermal energy. Examples of heaters (227) include infrared lamps, visible halogen lamps, resistive heaters, light emitting diodes LEDs, and lasers. As described above, build material may include a fusible build material that fuses together once a fusing temperature is reached. Accordingly, the heater (227) may apply thermal energy to the build material so as to heat portions of the build material past this fusing temperature. Those portions that are heated past the fusing temperature have a fusing agent disposed thereon and are formed in the pattern of the 3D object to be printed. The fusing agent increases the absorption rate of that portion of the build material. Thus, a heater (227) may apply an amount of energy such that those portions with an increased absorption rate reach a temperature greater than the fusing temperature while those portions that do not have the increased absorption rate to not reach a temperature greater than the fusing temperature. While specific reference is made to deposition of a fusing agent, an additive manufacturing apparatus (222) as described herein may apply any number of other functional agents.

As described above, build material particles may enter the fluid ejection devices (100) as the fluid ejection devices (100) pass over the build area (224). There may be many mechanisms that facilitate the ingress of build material particles into the fluid ejection devices (100). For example, the force of impact of fluid droplets from the fluid ejection device (100) may dislodge particulate matter in the build area (224) which may drift through the shared nozzle orifices (FIG. 1, 108) into the firing chambers (FIG. 1, 104). An electrostatic pull from components on the fluid ejection device (100) may further draw the particulate matter up into the fluid ejection device (100).

The multi-chamber (FIG. 1, 104) nozzles (102) of the fluid ejection devices (100-1, 100-2) prevent the entry of such particulate matter into the firing chambers (FIG. 1, 104) as described above in connection with FIG. 1.

While FIG. 2 specifically depicts a multi-chamber nozzle (102) as used in an additive manufacturing apparatus (222), such a multi-chamber nozzle (102) is also advantageous in a two-dimensional printing apparatuses. That is, the nozzle (102), as described in FIG. 1 could be used in a two-dimensional printing operation. For example, in latex printing, one chamber (FIG. 1, 104-1) could include, and dispense, color inks, and the other chamber (FIG. 1, 104-2) could include, and dispense latex/Wax globules. In this example, the multi-chamber nozzle (102) reduces the amount of supplies as both fluids can be ejected in a single multi-chamber nozzle (102).

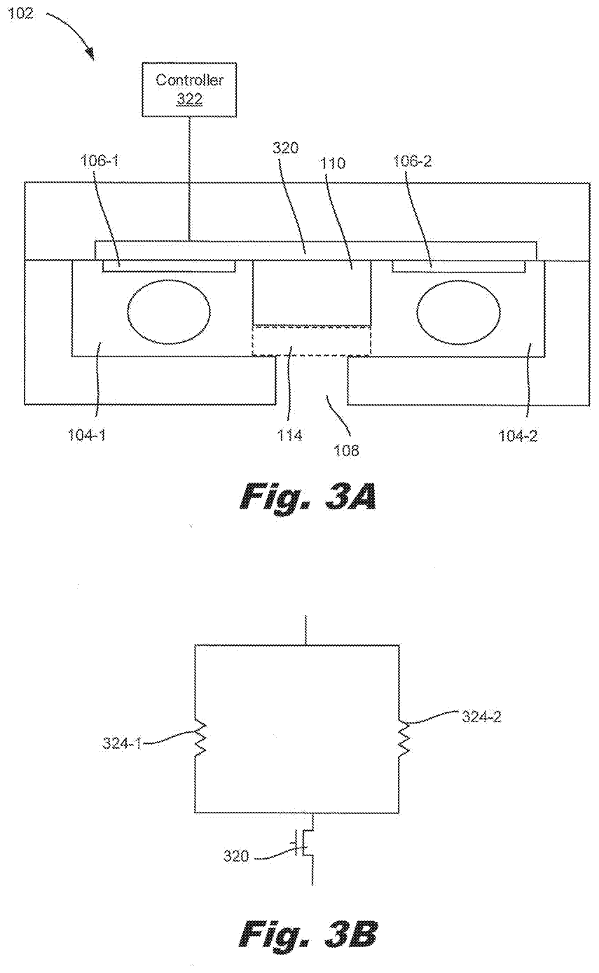

FIGS. 3A and 3B are diagrams of a multi-chamber nozzle (102) powered by a single power field-effect transistor (PowerFET) (320), according to an example of the principles described herein. Specifically, as described above in regards to FIG. 1, the nozzle (102) includes multiple firing chambers (104-1, 104-2) separated by a chamber partition (110). The chamber partition (110) also in part defines a common channel (114) through which fluid supplied from each of the firing chambers (104) is passed to a shared nozzle orifice (108) to be ejected.

An activating element, such as a field-effect transistor (320) is used to activate the ejectors (106-1, 106-2) to initiate the fluidic ejection operation. Specifically, as mentioned above, the ejectors (106) may be thermal resistors or piezo-resistive devices that eject fluid through fluid vaporization or operation of a pressure pulse. These ejectors (106) are activated by an electrical stimulus provided by the PowerFET (320). As depicted in FIG. 3A at least one controller (322) controls the supplication of the electrical stimulus to the single PowerFET (320). In other words, the number of controllers (322) is the same as the number of FETs (320) used to activate the multiple ejectors (106-1, 106-2).

As depicted in FIGS. 3A and 3B, in some examples, a single field-effect transistor (320) is used to activate the multiple ejectors (106-1, 106-2). In this example, the single PowerFET (320) passes an electrical stimulus to both the ejectors (106) at the same time. Doing so ensures synchronous activation of, and therefore synchronous firing of, the fluid through the shared nozzle orifice (108). FIG. 3B depicts a circuit diagram of the fluid ejection device (100) having a single PowerFET (320) to activate the multiple thermal resistors (324-1, 324-2).

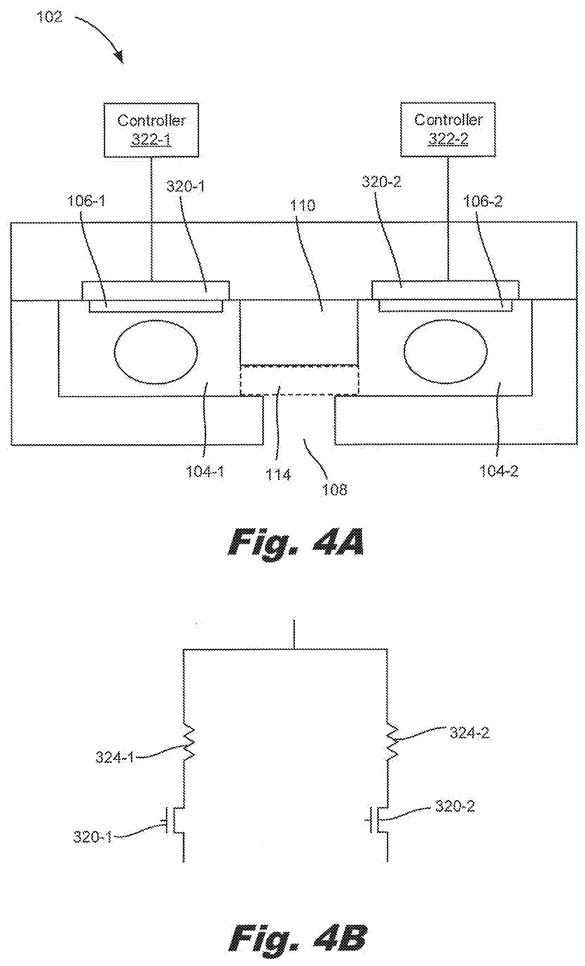

FIGS. 4A and 4B are diagrams of a multi-chamber nozzle (102) powered by multiple PowerFETs (320-1, 320-2), according to an example of the principles described herein. Specifically, as described above in regards to FIG. 1, the nozzle (102) includes firing chambers (104-1, 104-2) separated by a chamber partition (110). The chamber partition (110) also in part defines a common channel (114) through which fluid supplied from each of the firing chambers (104) is passed to a shared nozzle orifice (108) to be ejected.

An activating element, such as a field-effect transistor (320) is used to activate the ejectors (106) to initiate the fluidic ejection operation. Specifically, as mentioned above, the ejectors (106) may be thermal resistors or piezo-resistive devices that eject fluid through fluid vaporization or the operation of a pressure pulse. These ejectors (106) are activated by an electrical stimulus provided by the PowerFETs (320-1, 320-2). Specifically, a first field-effect transistor (320-1) activates a first ejector (106-1) and a second field-effect transistor (320-2) activates a second ejector (106-2). In this example, the PowerFETS (320-1, 320-2) pass electrical stimulus to corresponding ejectors (106). Using multiple PowerFETs (320) to control the multiple ejectors (106), one FET (320) per ejector (106) allows greater control over the ejection operation. For example, it may be desirable, to expel the fluid at different times, for example in a sequential manner. As a specific example, the first fluid chamber (104-1) may include a primary functional agent, and the second fluid chamber (104-2) may include an agent that activates the primary functional agent. Sequential firing of the ejectors (106-1, 106-2) may also counteract operations of the printing device. For example, as a printhead moves laterally over a medium, the fluid drop may be deposited at an angle resulting in mis-formed fluid drops. Sequential firing of ejectors may alter the angle of droplet ejection.

In another example, it may be desirable to provide a bigger activation pulse, so as to provide a larger fluid drop out of one of the firing chambers (106) relative to the other. FIG. 4B depicts a circuit diagram of the fluid ejection device (100) having multiple FETs (320) to activate the multiple thermal resistors (324-1, 324-2).

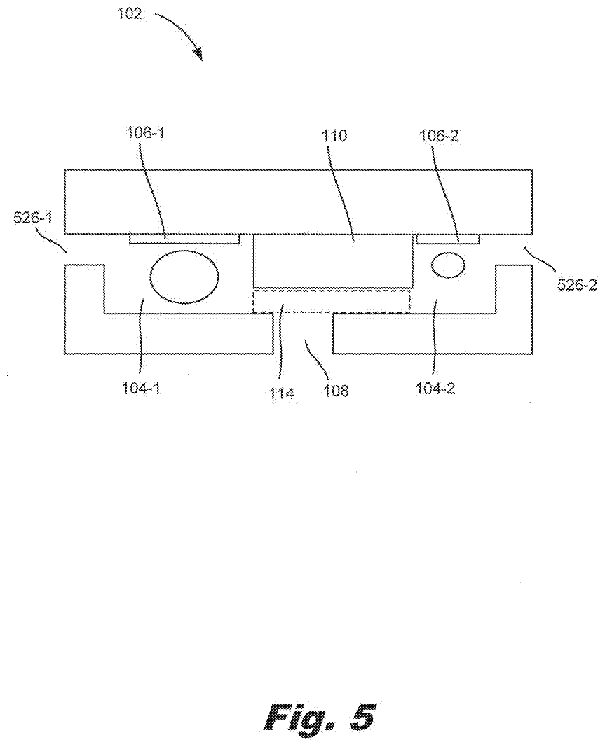

FIG. 5 is a diagram of a multi-chamber nozzle (102) having asymmetrical firing chambers (104-1, 104-2), according to an example of the principles described herein. That is, as depicted in FIG. 5, in some examples a first firing chamber (104-1) might be larger than a second firing chamber (104-2). Doing so facilitates the ejection of different sizes of fluid drops. Also, as depicted in FIG. 5, in some examples, multiple fluid feed channels (526) may separately provide fluid to the corresponding firing chambers (104). Specifically, a first fluid feed channel (526-1) may provide fluid to a first firing chamber (104-1) and a second fluid feed channel (526-2) may provide fluid to a second firing chamber (104-2). The fluid provided to each firing chamber (104) may be different. For example, the first fluid feed channel (526-1) may provide a first fluid to the first firing chamber (104-1) and the second fluid feed channel (526-2) may provide a second fluid to the second firing chamber (104-2).

Providing separate fluid feed channels (526) that can supply different amounts, and different kinds, of fluids to each firing chamber (106) facilitates the mixing of different fluids in different ratios. Moreover, described above if separate FETs (FIG. 3, 320) are used, not only can different types and different amounts of fluids be processed, but also the different fluids can be ejected at different times. Accordingly, in one example different quantities of different fluid can be mixed in the common channel (114), or if activated at sequential times, can be deposited on the medium at different times. For example, fluid from a first firing chamber (104-1) could be an ink deposited on a print media at one point in time, and fluid from a second firing chamber (104-2) could be a post-treatment fluid deposited after the ink at a different point in time.

Such control over fluid deposition also has uses outside of printing. For example, the first firing chamber (104-1) may contain, and the first ejector (106-1) eject, a reactive component, and the second firing chamber (104-2) may contain, and the second ejector (106-2) eject, a catalyst in a chemical application. Note that in all these examples, the height of the common channel (114) is still less than the width of the shared nozzle orifice (108), and a width of the chamber partition is greater than a width of the shared nozzle orifice (108) so as to prevent the entry of particulate matter into either of the firing chambers (104).

While FIG. 5 depicts separate fluid feed channels (526) per firing chamber (104), in some examples, both of the firing chambers (104) may be fed by a single fluid feed channel (526).

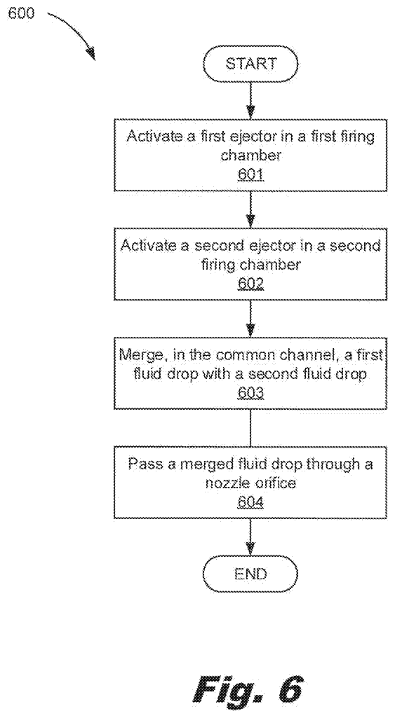

FIG. 6 is a flowchart of a method (600) for mixing fluids in a multi-chamber (FIG. 1, 104) nozzle (FIG. 1, 102) of a fluid ejection device (FIG. 1, 100), according to an example of the principles described herein. According to the method (600), a first ejector (FIG. 1, 106-1) in, a first firing chamber (FIG. 1, 104-1) is activated (block 601) to deliver fluid from the first firing chamber (FIG. 1, 104-1) to the common channel (FIG. 1, 114). As described above, the first ejector (FIG. 1, 106-1) may be a component such as a thermal resistor or a piezo-resistive element. The activation (block 601) of the first ejector (FIG. 1, 106-1) includes passing an electrical stimulus to the first ejector (FIG. 1, 106-1) to activate the ejecting mechanism of the ejector (FIG. 1, 106), which ejection mechanism may be heat or a pressure pulse. Similarly, a second ejector (FIG. 1, 106-2) in the second firing chamber (FIG. 1, 104-2) is activated (block 602) to deliver fluid from the second firing chamber (FIG. 1, 104-2) to the common channel (FIG. 1, 114). The first fluid drop from the first firing chamber (FIG. 1, 104-1) and the second fluid drop from the second firing chamber (FIG. 1, 104-2) are than merged (block 603) in the common channel (FIG. 1, 114). This merged fluid drop is then passed (block 604) through a shared nozzle orifice (FIG. 1, 108). Note that in this example, the shared nozzle orifice (FIG. 1, 108) has a width that is greater than a height of the common channel (FIG. 1, 114). Having a common channel (FIG. 1, 114) with a height less than a width of the shared nozzle orifice (FIG. 1, 104) ensures that foreign particulate matter does not enter into the firing chambers (FIG. 104) to adversely affect fluidic ejection.

In one example, using such a fluid ejection device with a multi-chamber nozzle 1) prevents clogging of the fluid ejection device, 2) maintains desirable fluid drop properties, 3) ejects foreign particulate matter away from the nozzle, 4) distributes firing energy among the multiple ejectors thus reducing electrical and thermal stress of the ejectors, and 5) provides or mixing different types, and different quantities, of fluid. However, it is contemplated that the devices disclosed herein may address other matters and deficiencies in a number of technical areas.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluid ejection device comprising:
a number of nozzles to eject fluid, each nozzle comprising:
multiple firing chambers to hold fluid, the multiple firing chambers separated by a chamber partition;
a shared nozzle orifice in a substrate through which to dispense fluid;
multiple ejectors, at least ejector disposed in each firing chamber; and
a common channel to mix fluid from the multiple firing chambers, wherein:
a height of the common channel is defined by the substrate and the chamber partition; and
the height of the common channel less than a width of the shared nozzle orifice bore size.

2. The fluid ejection device of claim 1, wherein a width of the chamber partition is greater than a width of the shared nozzle orifice.

3. The fluid ejection device of claim 1, wherein a height of the common channel is less than 50 micrometers.

4. The fluid ejection device of claim 1, further comprising a single power field-effect transistor to selectively activate the multiple ejectors.

5. The fluid erection device of claim 1, further comprising multiple power field-effect transistors, each power field-effect transistor to selectively activate one of the multiple ejectors.

6. The fluid ejection device of claim 1, wherein a first firing chamber has a different size than a second firing chamber.

7. The fluid election device of claim 1, wherein the fluid ejection device forms part of a two-dimensional printing system,

8. The fluid ejection device of claim 1, further comprising multiple fluid feed channels, each fluid feed channel to supply fluid to one of the multiple firing chambers.

9. An additive manufacturing apparatus comprising:
a build material distributor to successively deposit layers of build material into a build area;
at least one agent distributor including at least one fluid ejection device to selectively distribute agent onto the layers of build material;
a nozzle having multiple firing chambers, the nozzle to eject agent from the at least one fluid, ejection device; and
a heater to selectively fuse portions of the build material to form a three-dimensional object.

10. The apparatus of claim 9, wherein each of the multiple firing chambers provides a different fluid to a common channel to be mixed together.

11. The apparatus of claim 9, further comprising:
at least one power field-effect transistor to activate ejectors disposed within the multiple firing chambers; and
at least one controller to supply electrical energy to the at least one cower field-effect transistor, wherein the number of controllers is the same as the number of power field-effect transistors.

12. A method for ejecting fluid a fluid ejection device, comprising activating a first ejector in a first firing chamber to deliver fluid to a common channel of the fluid ejection device;
activating a second ejector in a second firing chamber to deliver fluid to the common channel;
merging, in the common channel, a first fluid drop from the first firing chamber with a second fluid drop from the second firing chamber;
passing a merged fluid drop through a shared nozzle orifice, which shared nozzle orifice has a width greater than a height of a common channel.

13. The method of claim 12, wherein:
fluid delivered to the common channel from the first firing chamber and the second firing chamber travel along a first plane; and
the merged fluid drop passes through the shared nozzle orifice along a second plane that is perpendicular to the second plane.

14. The method of clam 12, wherein activating the first ejector and activating the second ejector occur simultaneously.

15. The method of claim 12, wherein activating the first ejector and activating the second ejector occur sequentially.
